(19) United States
(12) Patent Application Publication
(10) Pub. No.: US 2014/0001904 A1
(43) Pub. Date: Jan. 2, 2014

(54) FLUID DYNAMIC BEARING ASSEMBLY AND SPINDLE MOTOR HAVING THE SAME, AND METHOD OF ASSEMBLING SHAFT AND STOPPER

(71) Applicant: SAMSUNG ELECTRO-MECHANICS CO., LTD., Suwon (KR)

(72) Inventor: Ik Sun LEE, Suwon (KR)

(73) Assignee: SAMSUNG ELECTRO-MECHANICS CO., LTD., Suwon (KR)

(21) Appl. No.: 13/668,976

(22) Filed: Nov. 5, 2012

(30) Foreign Application Priority Data
Jun. 29, 2012 (KR) 10-2012-0071343

(51) Int. Cl. F16C 32/06; B32B 37/12; H02K 7/08; B32B 37/10

(52) U.S. Cl. 310/90; 384/113; 156/293

(57) ABSTRACT

There are provided a fluid dynamic bearing assembly, a spindle motor having the same, and a method of assembling a shaft and a stopper, the fluid dynamic bearing assembly, including: a shaft, a sleeve rotatably supporting the shaft by fluid dynamic pressure, the shaft rotating relative thereto accordingly, and a stopper having a body inserted into a fixing recess provided on a lower portion of the shaft, and a flange provided to be protruded from a lower end of the body to an outer side thereof in a radial direction and caught by a lower end of the sleeve, wherein the stopper includes an air vent penetrating therethrough in an axial direction.

### CROSS-REFERENCE TO RELATED APPLICATIONS

This application claims the priority of Korean Patent Application No. 10-2012-0071343 filed on Jun. 29, 2012, in the Korean Intellectual Property Office, the disclosure of which is incorporated herein by reference.

### BACKGROUND OF THE INVENTION

1. Field of the Invention

The present invention relates to a fluid dynamic bearing assembly and a spindle motor having the same, and a method of assembling a shaft and a stopper.

2. Description of the Related Art

In general, a small spindle motor used in a hard disk drive (HDD) includes a fluid dynamic bearing assembly, and a bearing clearance provided in the fluid dynamic bearing assembly may be filled with a lubricating fluid.

When a shaft rotates, the lubricating fluid provided in the bearing clearance is pumped so that fluid dynamic pressure may be formed therein, so as to rotatably support the shaft.

Meanwhile, the shaft may include a stopper for preventing the shaft from being released from a sleeve in an event that an external impact is applied thereto.

When an external impact is applied to the shaft, the shaft floats upwardly of the sleeve and subsequently returns to its original position.

Namely, the shaft may repeatedly vibrate upwardly and downwardly in an axial direction due to external impacts, and impacts are continuously applied to the stopper by the vibrations due to repeated vibrations.

In other words, the stopper may be released from the shaft due to vibrations generated by external impacts, thereby degrading performance of a spindle motor due to vibrations.

### SUMMARY OF THE INVENTION

An aspect of the present invention provides a fluid dynamic bearing assembly in which a coupling distance of a shaft and a stopper is sufficiently secured, and a spindle motor.

Another aspect of the present invention provides a coupling structure of a shaft and a stopper in which air may not leak into a bearing clearance even in the case that a coupling scheme is employed.

According to an aspect of the present invention, there is provided a fluid dynamic bearing assembly including: a shaft; a sleeve rotatably supporting the shaft by fluid dynamic pressure, the shaft rotating relative thereto accordingly; and a stopper having a body inserted into a fixing recess provided on a lower portion of the shaft, and a flange provided to be protruded from a lower end of the body to an outer side thereof in a radial direction and caught by a lower end of the sleeve, wherein the stopper includes an air vent penetrating therethrough in an axial direction.

The body may be slidably coupled to the fixing recess.

The body and the shaft may have an adhesive provided therebetween in the fixing recess.

At least a portion of the air vent may be finished by the adhesive.

According to another aspect of the present invention, there is provided a fluid dynamic bearing assembly including: a shaft; a sleeve rotatably supporting the shaft by fluid dynamic pressure, the shaft rotating relative thereto accordingly; and a stopper having a body inserted into a fixing recess provided on a lower portion of the shaft, and a flange provided to be protruded from a lower end of the body to an outer side thereof in a radial direction and caught by a lower end of the sleeve, wherein the stopper includes an air vent penetrating an upper end thereof and the fixing recess in the axial direction.

The body may include an adhesive support provided on an upper surface thereof in a position corresponding to the air vent.

The adhesive support may have an adhesive applied thereto to block the air vent.

According to another aspect of the present invention, there is provided a method of assembling a shaft and a stopper, including: preparing a shaft having a fixing recess formed in a lower end thereof, into which a stopper is insertedly fixed; preparing a stopper having a body inserted into fixing recess and a flange protruded from a lower end of the body to an outer side in a radial direction, and having an air vent penetrating therethrough in an axial direction; applying an adhesive to the fixing recess of the shaft; slidably coupling the body of the stopper to the fixing recess; and pressurizing the stopper into the fixing recess such that the adhesive is provided between the upper end of the body and the upper surface of the fixing recess and subsequently provided from the upper end of the body toward a lower end thereof along the air vent.

The adhesive may be provided down to a lower end of the air vent.

According to another aspect of the present invention, there is provided a method of assembling a shaft and a stopper, including: preparing a shaft having a fixing recess formed in a lower end of the shaft, into which a stopper is insertedly fixed, and having an air vent penetrating an upper end of the shaft and the fixing recess; preparing the stopper having a body inserted into the fixing recess provided on a lower portion of the shaft and a flange protruded from a lower end of the body to an outer side in a radial direction; applying an adhesive to side walls of the fixing recess and an upper surface of the body; slidably coupling the body of the stopper to the fixing recess; and pressurizing the stopper into the fixing recess such that the adhesive is provided between the upper end of the body and the upper surface of the fixing recess and subsequently provided from a lower end of the shaft toward an upper end thereof along the air vent.

The body may include an adhesive support provided on an upper surface thereof in a position corresponding to the air vent, and the body may be slidably coupled to the fixing recess after the adhesive is applied to the adhesive support.

According to another aspect of the present invention, there is provided a spindle motor including: a base member to which the fluid dynamic bearing assembly as described above is fixed; a stator core installed on an outer surface of the sleeve; and a rotor hub fixed to an upper end of the shaft and having a magnet electromagnetically interacting with the stator core.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a spindle motor according to an embodiment of the present invention;

FIG. 2 is an enlarged sectional view of a shaft assembly illustrated in FIG. 1;

FIG. 3 is a cross-sectional view illustrating a spindle motor according to an embodiment of the present invention;

FIG. 4 is an enlarged sectional view of a shaft assembly illustrated in FIG. 3;

FIGS. 5A through 5F are sequential sectional views of members, illustrating a process of manufacturing the shaft assembly illustrated in FIG. 2; and

FIGS. 6A through 6F are sequential sectional views of members, illustrating a process of manufacturing the shaft assembly illustrated in FIG. 4.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

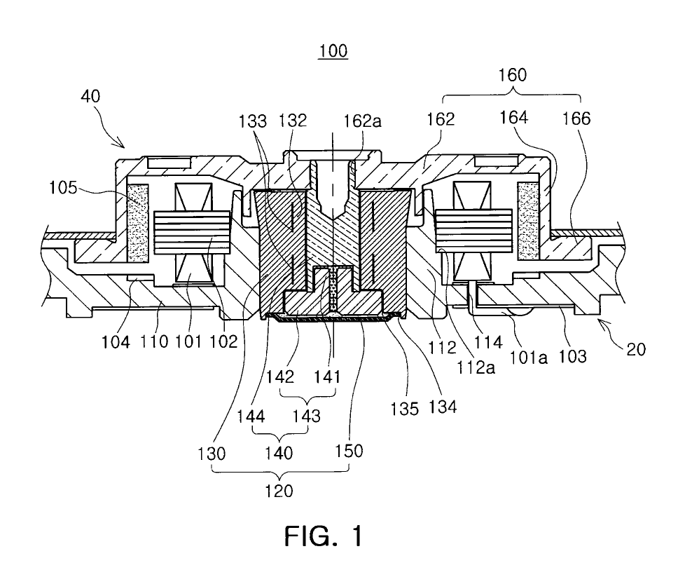

FIG. 1 is a cross-sectional view illustrating a spindle motor according to an embodiment of the present invention, and

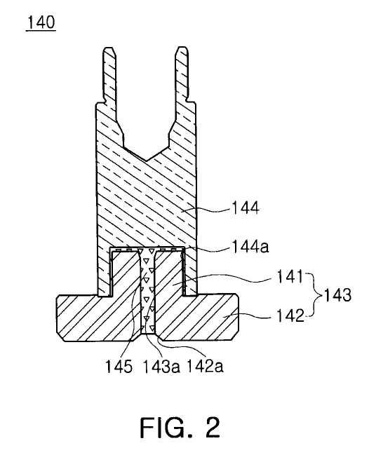

FIG. 2 is an enlarged sectional view of a shaft assembly illustrated in FIG. 1.

Referring to FIGS. 1 and 2, a spindle motor 100 according to an embodiment of the present invention may include, for example, a base member 110, a fluid dynamic bearing assembly 120, and a rotor hub 160.

Also, the fluid dynamic bearing assembly 120 according to an embodiment of the present invention may include, for example, a sleeve 130, a shaft assembly 140, and a cover member 150.

Meanwhile, the spindle motor 100 according to the embodiment of the present invention may be a motor applied to a recording disk driving device for rotating a recording disk.

Here, directional terms are defined as follows. An axial direction refers to a vertical direction, namely, a downward direction from an upper portion of a shaft 144 thereof or an upward direction from the lower portion of the shaft 144 as viewed in FIG. 1, and a radial direction refers to a horizontal direction, namely, a direction from an outer circumferential surface of a rotor hub 160 toward the shaft 144 or a direction from the shaft 144 toward the outer circumferential surface of the rotor hub 160 as viewed in FIG. 1.

Also, a circumferential direction refers to a direction rotating along an outer circumferential surface of the rotor hub 160 and the shaft 144.

Meanwhile, the spindle motor 100 according to an embodiment of the present invention may include a stator 20 and a rotor 40. The stator 20 refers to every body member that rotatably supports the rotor 40, and the rotor 40 refers to a rotatable member, rotatably supported by the stator 20.

The base member 110, a body member included in the stator rotatably supporting the rotor 40, may include an installation unit 112 in which a sleeve 130 provided in the fluid dynamic bearing assembly 120 is installed.

The base member 110 may be fabricated by die-casting aluminum (Al) or performing plastic-working (pressing, or the like) on a rolled plate.

The installation unit 112 is formed to be protruded upwardly in the axial direction, and the sleeve 130 is insertedly installed in the installation unit 112. When the base member 110 is fabricated by performing plastic-working on a rolled plate, the installation unit 112 may be fabricated as a separate member and coupled to the base member 110.

A stator core 102 with a coil 101 wound therearound may be installed on an outer circumferential surface of the installation unit 112. Namely, in a state in which the stator core 102 is mounted on a mounting surface 112a formed on the outer circumferential surface of the installation unit 112, the stator core 102 may be fixedly installed with an adhesive and/or through welding.

Meanwhile, the base member 110 may include a lead-out hole 114 formed to be disposed in the vicinity of the installation unit 112. A lead portion 101a of the coil 101 wound around the stator core 102 may be led from an upper side of the base member 110 to a lower side thereof through the lead-out hole 114.

Also, a circuit board 103 to which the lead portion 101a of the coil 101 is bonded may be installed on a lower surface of the base member 110. The circuit board 103 may be configured as a flexible circuit board.

Meanwhile, a pulling plate 104 may be installed on the base member 110 in order to prevent the rotor hub 160 from being floated excessively. The pulling plate 104 may have an annular shape. Here, however, when the base member 110 is fabricated by performing plastic-working on a rolled plate, the base member 110 assumes magnetism, so a separate pulling plate 104 may not be necessary.

As discussed above, the fluid dynamic bearing assembly 120 may include the sleeve 130, the shaft assembly 140, and the cover member 150, and has a bearing clearance provided with a lubricating fluid.

When the shaft assembly 140 is rotated, the lubricating fluid provided in the bearing clearance is pumped to allow the shaft assembly 140 to be more stably rotated.

Meanwhile, the sleeve 130 is a body member constituting the stator 20 together with the base member 110, and is fixedly installed in the installation unit 112. Namely, an outer circumferential surface of the sleeve 120 may be bonded to an inner circumferential surface of the installation unit 112 by an adhesive or the sleeve 120 may be press-fitted into the installation unit 112 so as to be installed therein.

An axial hole 132 may be formed in the sleeve 130 to allow the shaft assembly 140 to be insertedly installed therein. Namely, the sleeve 130 may have a hollow cylindrical shape.

Meanwhile, when the shaft assembly 140 is insertedly disposed in the sleeve 130, an inner circumferential surface of the sleeve 130 and an outer circumferential surface of the shaft assembly 140 may be spaced apart from one another by a predetermined interval so as to form a bearing clearance therebetween. The lubricating fluid is provided in the bearing clearance.

Also, a dynamic pressure groove 133 may be formed in an inner surface of the sleeve 130 in order to pump the lubricating fluid provided in the bearing clearance to generate fluid dynamic pressure when the shaft assembly 140 is rotated.

A mounting recess 134 for allowing the cover member 150 to be installed and an embayment recess 135 formed to have a step with respect to the mounting recess 134 may be formed in a lower end portion of the sleeve 130.

This will be described in detail later.

The shaft assembly 140, a rotary member constituting the rotor 40, is rotatably supported by the sleeve 130 and includes a stopper 143 insertedly disposed in the embayment recess 135.

Meanwhile, the shaft assembly 140 may include the shaft 144 having a cylindrical shape and the stopper 143 fastened to a lower end portion of the shaft 144.

The stopper 143 may include a body 141 insertedly installed in a fixing recess 144a provided on a lower end of the shaft 144 and a flange 142 formed to extend to be protruded in a radial direction from an end of the body 141.

The shaft assembly 140 may be insertedly disposed in the axial hole 132 of the sleeve 130, and an upper end portion of the shaft assembly 140 may be disposed to be protruded upwardly of an upper portion of the sleeve 130.

Also, the rotor hub 160 may be fixedly installed on an upper end portion of the shaft assembly 140.

When external impact is applied, the flange 142 of the stopper 143 is caught by a lower end of the sleeve 130 to prevent the shaft assembly 140 from being released from the sleeve 130.

Meanwhile, in an embodiment of the present invention, the stopper 143 includes an air vent 143a formed in a penetrative manner in the axial direction. The air vent 143a allows air provided in the fixing recess 144a to be naturally discharged when the body 141 of the stopper 143 is coupled to the fixing recess 144a of the shaft 144.

In addition, an adhesive is applied to the interior of the fixing recess 144a before the shaft 144 and the stopper 143 are coupled. The applied adhesive is provided between an outer circumferential surface of the body 141 and an inner circumferential surface of the fixing recess 144a when the body 141 is inserted into the fixing recess 144a.

When the stopper 143 is further pressurized to be attached to the fixing recess 144a, the adhesive is inserted along the air vent 143a from an upper side of the stopper 143 toward a lower side thereof, filling the air vent 143a.

With such a configuration, the fixing recess 144a may be fully provided with the body 141 and the adhesive by the simple coupling of the shaft 144 and the stopper 143. Thus, even in the case that the shaft assembly 140 is used in the fluid dynamic bearing assembly 120, there is no possibility that air will leak into the bearing clearance.

Meanwhile, a chamfered portion 142a may be formed on a lower end of the air vent 143a provided in the stopper 143. The air vent 143a is formed to have a relatively very small diameter, so in the process of filling the fluid dynamic bearing assembly 120 with the lubricating fluid, the lubricating fluid may be provided with air collected therein at the lower end of the air vent 143a. The chamfered portion 142a serves to prevent this defect.

The cover member 150 is a fixed member constituting the stator 20 together with the base member 110 and the sleeve 130. The cover member 150 is installed on the sleeve 130 such that it is disposed under the stopper 143. Namely, the cover member 150 is fixedly installed in the mounting recess 134 of the sleeve 130.

An upper surface of the cover member 150 is disposed to face a lower surface of the stopper 143, and the lubricating fluid is also provided in a gap between the upper surface of the cover member 150 and the lower surface of the stopper 143.

The cover member 150 serves to prevent the lubricating fluid provided in the bearing clearance to be leaked to a lower end portion of the sleeve 130.

The rotor hub 160 is a rotary member constituting the rotor 40 together with the shaft 144. The rotor hub 160 is fixedly installed on an upper end portion of the shaft 144 and rotates together with the shaft 144.

Meanwhile, the rotor hub 160 may include a body 162 having a disk-like shape, a magnet coupling unit 164 extending from the edge of the body 162 toward a lower portion in the axial direction, and a disk mounting unit 166 extending from a lower end portion of the magnet coupling unit 164 to an outer side thereof in the radial direction to allow a disk to be mounted thereon.

A mounting hole 162a may be provided in the body 162. The shaft 144 is fixed in the mounting hole 162a. The mounting hole 162a may be formed at a central portion of the body 162.

Meanwhile, a driving magnet 105 is installed on an inner surface of the magnet coupling unit 164. The driving magnet 105 may be disposed at a front edge of the stator core 102 around which the coil 101 is wound. Also, the driving magnet 105 may have an annular shape and may be a permanent magnet having an N pole and an S pole alternately magnetized in the circumferential direction to generate magnetic force having a predetermined strength.

Here, rotatable driving of the rotor hub 160 will be described in brief. When power is supplied to the coil 101 wound around the stator core 102, driving force for rotating the rotor hub 160 is generated according to electromagnetic interaction between the driving magnet 105 and the stator core 102 with the coil wound therearound.

Accordingly, the rotor hub 160 is rotated, and as a result, the shaft 144 to which the rotor hub 160 is fixedly coupled is rotated together with the rotor hub 160.

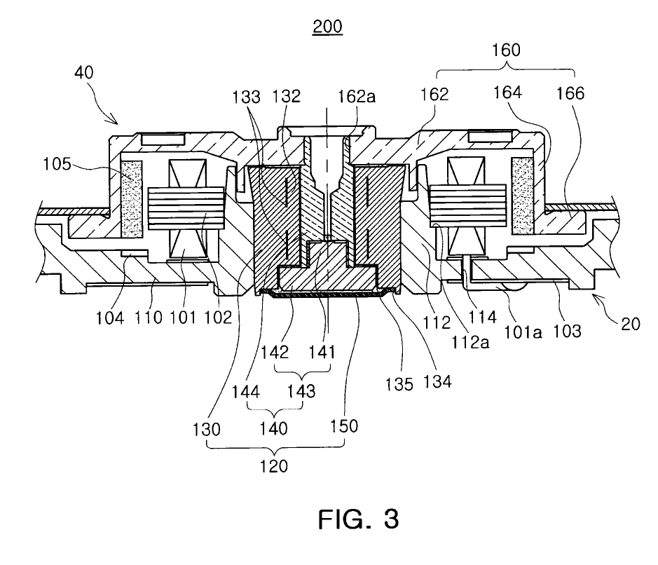

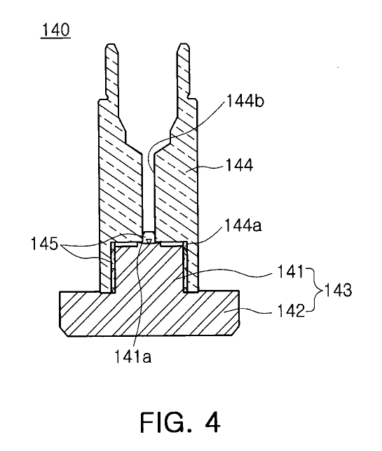

FIG. 3 is a cross-sectional view illustrating a spindle motor according to an embodiment of the present invention, and FIG. 4 is an enlarged cross-sectional view of a shaft assembly illustrated in FIG. 3.

Referring to FIGS. 3 and 4, a spindle motor 200 according to an embodiment of the present invention is different from the spindle motor 100 according to the embodiment described above with reference to FIGS. 1 and 2, in the aspect of the positions of the spindle motor 100 and the air vent. Thus, a detailed description of the same structure and shape will be omitted in order to avoid confusion and for clarification. Hereinafter, differences of the spindle motor 200 from the spindle motor 100 according to the embodiment of the present invention as described above with reference to FIGS. 1 and 2 will be largely described.

The spindle motor 200 according to the embodiment of the present invention may include the shaft assembly 140 including the shaft 144 and the stopper 143. However, in the shaft assembly 140, air provided in the fixing recess 144a of the shaft 144 during a process of coupling the shaft 144 and the stopper 143 may be discharged through an air vent 144b provided in the shaft 144.

The shaft 144 of the spindle motor 200 according to an embodiment of the present invention may have the air vent 144b penetrating an upper end thereof and the fixing recess 144a. Also, in order to finish the air vent 144b, an adhesive support 141a may be provided in the stopper 143. The spindle motor 200 according to the present embodiment may also be coupled without having the adhesive support 141a like the spindle motor 100 according to the embodiment of the present invention as described above with reference to FIGS. 1 and 2. However, in the case of the spindle motor 200 according to the present embodiment, since the air vent 144b is provided in the shaft 144, the adhesive 145 may be applied to an upper surface of the body 141.

In detail, in the present embodiment of the invention, the air vent 144b is formed to penetrate the shaft 144 in the axial direction. The air vent 144b allows air provided in the fixing recess 144a to be naturally discharged when the body 141 of the stopper 143 is coupled to the fixing recess 144a of the shaft 144.

In addition, before the shaft 144 and the stopper 143 are coupled, an adhesive is applied to a side wall (i.e., a wall positioned in the radial direction) of the fixing recess 144a. The applied adhesive 145 is provided between the outer circumferential surface of the body 141 and the inner face of the fixing recess 144a when the body 141 is inserted into the fixing recess 144a.

In addition, the adhesive support 141a is provided on an upper surface of the body 141 and the adhesive 145 may be applied to the adhesive support 141a before the body 141 is inserted into the fixing recess 144a.

When the stopper 143 is attached to the fixing recess 144a under pressure, the adhesive 145 is thrown out in an outward direction (i.e., from a lower side toward an upper side in the axial direction of the fixing recess), that is, in the direction of the fixing recess 144a along the air vent 144b, filling a portion of the air vent 144b. In particular, the adhesive 145 fills a gap where the air vent 144b meets the fixing recess 144a.

Through such a configuration, air provided in the fixing recess 144a may be entirely discharged to the outside even in the case of the coupling of the shaft 144 and the stopper 143, and since the air vent 144b is finished by the adhesive 145 after air is discharged, air cannot come into the fixing recess 144a. Thus, even in the case that the shaft assembly 140 is used in the fluid dynamic bearing assembly 120, there is no possibility that air will leak into the bearing clearance.

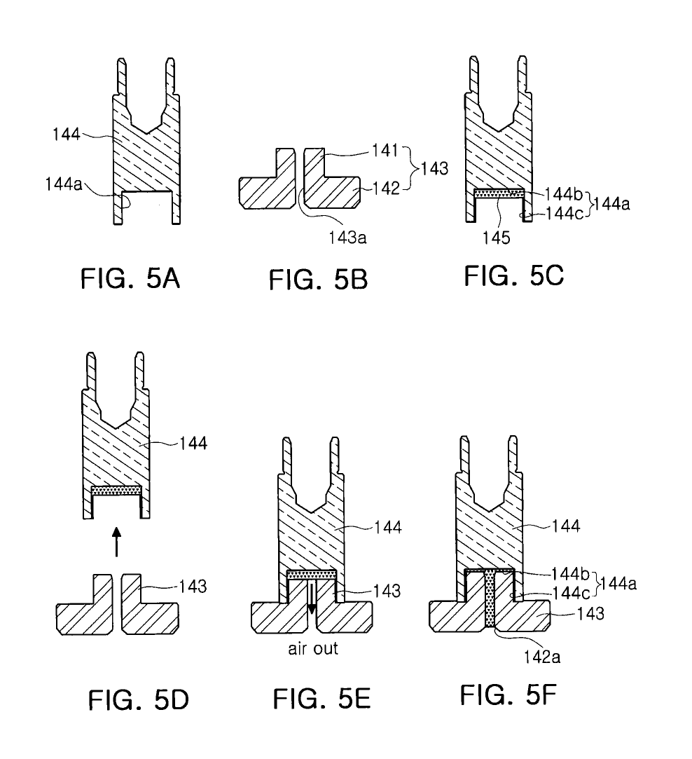

FIGS. 5A through 5F are sequential sectional views of members, illustrating a process of manufacturing the shaft assembly illustrated in FIG. 2. Hereinafter, a process of manufacturing the shaft assembly of the spindle motor 100 according to an embodiment of the present invention will be described with reference to FIGS. 5A through 5F.

The shaft assembly 140 of the spindle motor 100 according to the afore-mentioned embodiment of the present invention has a structure in which the fixing recess 144a is provided in a lower portion of the shaft 144 to allow the body 141 of the stopper 143 to be insertedly fixed within the fixing recess 144a.

Through such a structure, a sufficient bonding length may be secured in the length direction of the shaft 144, thereby enhancing coupling strength of the shaft 144 and the stopper 143.

This structure, however, has a defect in that air provided in the fixing recess 144a may not be entirely discharged in the process of inserting the body 141 of the stopper 143 into the fixing recess 144a. The shaft assembly 140 is applied to the spindle motor using the fluid dynamic bearing assembly, and thus, when air is collected within the shaft assembly 140, air will leak into the bearing clearance afterwards to negatively affect motor performance. Thus, in the present embodiment, a method of manufacturing the shaft assembly 140 which does not allow for air to remain within the shaft assembly 140 may be provided.

Namely, an air vent 143a is provided in the stopper 143, penetrating therethrough in the axial direction, whereby air provided in the fixing recess 144a of the shaft 144 may be naturally discharged along the air vent 141a in the process of coupling the stopper 143 to the shaft 144.

In addition, the air vent 141a may be finished by an adhesive provided from an inner side to an outer side. Thus, even in the case that the shaft assembly 140 is used in a fluid dynamic bearing assembly of a spindle motor afterwards, air leakage from the shaft assembly 140 into a lubricating fluid may not occur.

Hereinafter, the process of coupling the stopper 143 to the shaft 144 will be described in detail.

First, the shaft 144 having the fixing recess 144a into which the stopper 143 is insertedly fixed at a lower end thereof is prepared (FIG. 5A). The fixing recess 144a may be formed to have a predetermined height in an upward direction from a lower portion of the shaft 144 in the axial direction.

Next, the stopper 143 having the body 141 inserted into the fixing recess 144a, the flange 142 protruded outwardly from a lower end of the body 141 in the radial direction, and the air vent 141a penetrating therethrough in the axial direction is prepared (FIG. 5B).

And then, the adhesive 145 is applied to the fixing recess 144a of the shaft 144 (FIG. 5C). The adhesive 145 is applied to the entirety of the upper surface 144b and side walls 144c of the fixing recess 144a.

Thereafter, the body 141 of the stopper 143 is slidably coupled to the fixing recess 144a (FIGS. 5D and 5E). When the body 141 is slidably coupled to the fixing recess 144a, the body 141 is inserted from a lower side of the shaft 144 in the upward direction along the side walls 144c of the fixing recess 144a, so the adhesive 145 applied to the side walls 144c and the upper surface 144b gathers toward the upper surface 144b of the fixing recess 144a. The adhesive may also be applied between the body 141 and the side walls 144c to bond them.

And then, in the state in which the adhesive 145 is provided between the upper end of the body 141 and the upper surface 144b of the fixing recess 144a, the body 141 of the stopper 143 is pressurized into the fixing recess 144a to allow the adhesive 145 to be provided from an upper end of the body 141 toward a lower end thereof along the air vent 141a (FIG. 5F). Accordingly, the air vent 141a is provided with the thrust adhesive 145 from the upper end of the stopper 143 toward the lower end thereof.

In the process of applying the adhesive 145 to the fixing recess 144a, an appropriate amount of adhesive 145 may be applied such that it is provided down to the lower end of the air vent 141a after the shaft 144 and the stopper 143 are coupled.

However, it may be difficult to accurately assume the amount of the adhesive to be provided down to the lower end of the air vent 141a. Thus, the chamfered portion 142a may be provided on the lower end of the air vent 141.

The air vent 141a has a substantially, relatively small diameter, so in a case in which the adhesive 145 is not provided down to the lower end of the air vent 141a, the lower end of the air vent 141a may be maintained in a state of being filled with air. Also, when the shaft assembly 140 with air provided in the lower end of the air vent 141a is applied to a fluid dynamic bearing assembly of a spindle motor, a lubricating fluid may be provided in the bearing clearance in the state in which air is not exhausted. So, when the motor is operated afterwards, air is leaked into the lubricating fluid to negatively affect the operation of the motor.

Thus, the chamfered portion 142a is provided on the lower end of the air vent 141a to increase a diameter of the lower end portion of the air vent 141a, whereby even in the case that the adhesive 145 is not provided down to the lower end of the air vent 141a, the possibility that air remains in the remaining portion of the air vent 141a may be significantly reduced.

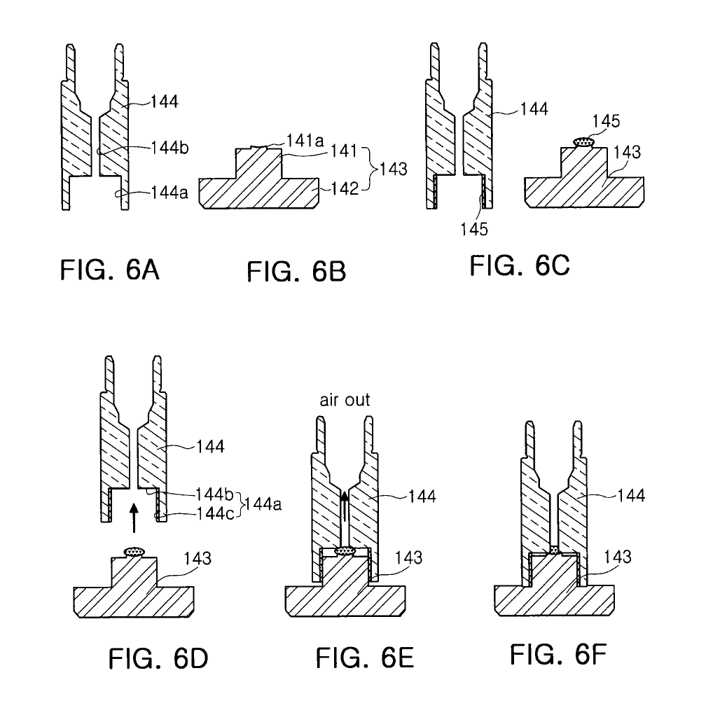

FIGS. 6A through 6F are sequential cross-sectional views of members illustrating a process of manufacturing the shaft assembly illustrated in FIG. 4. A process of manufacturing the shaft assembly of the spindle motor 200 according to an embodiment of the present invention will be described with reference to FIGS. 6A through 6F. In comparison to the process of manufacturing the shaft assembly of the spindle motor 100 according to the embodiment of the present invention as described above with reference to FIGS. 5A through 5F, there is a difference in the position of the air vent. Thus, a detailed description of the same structures and shapes will be omitted in order to avoid confusion and for clarification. Hereinafter, the difference of the spindle motor 200 from the spindle motor 100 according to the embodiment of the present invention as described above with reference to FIGS. 5A through 5F will be largely described.

The spindle motor 200 according to an embodiment of the present invention may include the shaft assembly 140 including the shaft 144 and the stopper 143. However, in the shaft assembly 140, air provided in the fixing recess 144a of the shaft 144 during a process of coupling the shaft 144 and the stopper 143 may be discharged through an air vent 144b provided in the shaft 144.

The shaft 144 of the spindle motor 200 according to an embodiment of the present invention may have the air vent 144b penetrating an upper end thereof and the fixing recess 144a. Also, in order to finish the air vent 144b, an adhesive support 141a may be provided in the stopper 143.

Hereinafter, the process of coupling the stopper 143 to the shaft 144 will be described in detail.

First, the shaft 144 having the fixing recess 144a into which the stopper 143 is insertedly fixed and the air vent 144b penetrating the upper end and the fixing recess 144a is prepared (FIG. 6A).

Next, the stopper 143 having the body 141 inserted into the fixing recess 144a provided at a lower portion of the shaft 144 and the flange 142 protruded outwardly from a lower end of the body 141 in the radial direction is prepared (FIG. 6B-Here, it is illustrated that the adhesive support 141a is provided on an upper surface of the body 141).

Then, an adhesive is applied to the side walls 144c of the fixing recess 144a and an upper surface of the body 141 (FIG. 6C—Here, it is illustrated that the adhesive support 141a is provided on an upper surface of the body 141).

Thereafter, the body 141 of the stopper 143 is slidably coupled to the fixing recess 144a (FIGS. 6D and 6E—Here, it is illustrated that the adhesive support 141a is provided on an upper surface of the body 141). When the body 141 is slidably coupled to the fixing recess 144a, the body 141 is inserted from a lower side of the shaft 144 in the upward direction along the side walls 144c of the fixing recess 144a, so the adhesive 145 applied to the side walls 144c gathers toward the upper surface 144b of the fixing recess 144a. The adhesive may also be applied between the body 141 and the side walls 144c to bond them.

And then, in the state in which the adhesive 145 applied to the side walls 144c and gathered toward the upper surface 144b and the adhesive 145 applied to the upper surface of the body 141 are provided between the upper end of the body 141 and the upper surface 144b of the fixing recess 144a, the stopper 143 is pressurized into the fixing recess 144a to allow the adhesive 145 to be provided from a lower end of the shaft 144 toward an upper end thereof along the air vent 144b (FIG. 6F—Here, it is illustrated that the adhesive support 141a is provided on an upper surface of the body 141).

Here, the shaft assembly used in the spindle motor 200 according to the present embodiment of the invention may have the adhesive support 141a provided in a position corresponding to the air vent 144b at an upper end of the body 141. Also, after the adhesive 145 is applied to the adhesive support 141a, the body 141 may be slidably coupled to the fixing recess 144a. The adhesive support 141a is provided in a position corresponding to the air vent 144b to directly finish the air vent 144b, thereby completely blocking the fixing recess 144a against the outside. Thus, an air inflow may be effectively blocked.

As set forth above, according to embodiments of the invention, since the fluid dynamic bearing assembly and the spindle motor may sufficiently secure the length of coupling the shaft and the stopper, the bonding strength between the shaft and the stopper may be enhanced.

Also, the structure of coupling between the shaft and the stopper, in which air may not leak into a bearing clearance even in the case that such a coupling scheme is employed, may be provided.

While the present invention has been shown and described in connection with the embodiments, it will be apparent to those skilled in the art that modifications and variations can be made without departing from the spirit and scope of the invention as defined by the appended claims.

What is claimed is:

1. A fluid dynamic bearing assembly comprising:
a shaft;
a sleeve rotatably supporting the shaft by fluid dynamic pressure, the shaft rotating relative thereto accordingly; and
a stopper having a body inserted into a fixing recess provided on a lower portion of the shaft, and a flange provided to be protruded from a lower end of the body to an outer side thereof in a radial direction and caught by a lower end of the sleeve,
the stopper including an air vent penetrating therethrough in an axial direction.

2. The fluid dynamic bearing assembly of claim 1, wherein the body is slidably coupled to the fixing recess.

3. The fluid dynamic bearing assembly of claim 1, wherein the body and the shaft have an adhesive provided therebetween in the fixing recess.

4. The fluid dynamic bearing assembly of claim 1, wherein at least a portion of the air vent is finished by the adhesive.

5. A fluid dynamic bearing assembly comprising:
a shaft;
a sleeve rotatably supporting the shaft by fluid dynamic pressure, the shaft rotating relative thereto accordingly; and
a stopper having a body inserted into a fixing recess provided on a lower portion of the shaft, and a flange provided to be protruded from a lower end of the body to an outer side thereof in a radial direction and caught by a lower end of the sleeve,
the stopper including an air vent penetrating an upper end thereof and the fixing recess in the axial direction.

6. The fluid dynamic bearing assembly of claim 5, wherein the body includes an adhesive support provided on an upper surface thereof in a position corresponding to the air vent.

7. The fluid dynamic bearing assembly of claim 6, wherein the adhesive support has an adhesive applied thereto to block the air vent.

8. A method of assembling a shaft and a stopper, the method comprising:
preparing a shaft having a fixing recess formed in a lower end thereof, into which a stopper is insertedly fixed;
preparing a stopper having a body inserted into fixing recess and a flange protruded from a lower end of the body to an outer side in a radial direction, and having an air vent penetrating therethrough in an axial direction;
applying an adhesive to the fixing recess of the shaft;
slidably coupling the body of the stopper to the fixing recess; and
pressurizing the stopper into the fixing recess so as to allow for the adhesive to be provided between the upper end of the body and the upper surface of the fixing recess and be subsequently provided from the upper end of the body toward a lower end thereof along the air vent.

9. The method of claim 8, wherein the adhesive is provided down to a lower end of the air vent.

10. A method of assembling a shaft and a stopper, the method comprising:
preparing a shaft having a fixing recess formed in a lower end of the shaft, the fixing having a stopper insertedly fixed thereinto, and having an air vent penetrating an upper end of the shaft and the fixing recess;
preparing the stopper having a body inserted into the fixing recess provided on a lower portion of the shaft and a flange protruded from a lower end of the body to an outer side in a radial direction;
applying an adhesive to side walls of the fixing recess and an upper surface of the body;
slidably coupling the body of the stopper to the fixing recess; and
pressurizing the stopper into the fixing recess such that the adhesive is provided between the upper end of the body and the upper surface of the fixing recess and subsequently provided from a lower end of the shaft toward an upper end thereof along the air vent.

11. The method of claim 10, wherein the body includes an adhesive support provided on an upper surface thereof in a position corresponding to the air vent, and the body is slidably coupled to the fixing recess after the adhesive is applied to the adhesive support.

12. A spindle motor comprising:
a base member including the fluid dynamic bearing assembly fixed thereto according to claim 1;
a stator core installed on an outer surface of the sleeve; and
a rotor hub fixed to an upper end of the shaft and having a magnet electromagnetically interacting with the stator core.

13. A spindle motor comprising:
a base member including the fluid dynamic bearing assembly fixed thereto according to claim 5;
a stator core installed on an outer surface of the sleeve; and
a rotor hub fixed to an upper end of the shaft and having a magnet electromagnetically interacting with the stator core.
